(19) United States
(12) Patent Application Publication
(10) Pub. No.: US 2023/0171427 A1
(43) Pub. Date: Jun. 1, 2023

(54) Method, An Apparatus and a Computer Program Product for Video Encoding and Video Decoding

(71) Applicant: Nokia Technologies Oy, Espoo (FI)

(72) Inventors: Christoph Bachhuber, Munich (DE); Lukasz Kondrad, Munich (DE); Sebastian Schwarz, Unterhaching (DE); Lauri Aleksi Ilola, Tampere (FI); Patrice Rondao Alface, Evere (BE); Aleksei Martemianov, Tampere (FI); Jozsef Szabo, Tampere (FI)

(21) Appl. No.: 18/071,785

(22) Filed: Nov. 30, 2022

(30) Foreign Application Priority Data
Nov. 30, 2021 (FI) 20216222

(51) Int. Cl. H04N 19/597; H04N 19/105; H04N 19/177

(52) U.S. Cl. CPC H04N 19/597; H04N 19/105; H04N 19/177

(57) ABSTRACT

The embodiments relate to a method for encoding including receiving a sequence of volumetric video frames including a volumetric visual object being defined with a mesh of interconnected vertices; selecting one or more reference frames from the sequence of volumetric video frames for a group of pictures; clustering a mesh of the one or more reference frames into patches, each patch being associated with a corresponding bounding volume; creating matching patches in frames dependent on the reference frame; estimating scaling and rotation parameters for each individual patch in the dependent frame; applying the estimated scaling and rotation parameters to bounding volume of a patch of the dependent frames; packing the patches to an atlas bitstream of a volumetric video stream and including into a bitstream the estimated rotation parameter alongside the bounding volume of a patch. The embodiments also relate to a method for decoding, and corresponding equipment.

### TECHNICAL FIELD

The present solution generally relates to encoding and decoding of volumetric video.

### BACKGROUND

Volumetric video data represents a three-dimensional (3D) scene or object, and can be used as input for AR (Augmented Reality), VR (Virtual Reality), and MR (Mixed Reality) applications. Such data describes geometry (Shape, size, position in 3D space) and respective attributes (e.g., color, opacity, reflectance, . . . ), and any possible temporal transformations of the geometry and attributes at given time instances (like frames in 2D video). Volumetric video can be generated from 3D models, also referred to as volumetric visual objects, i.e., CGI (Computer Generated Imagery), or captured from real-world scenes using a variety of capture solutions, e.g., multi-camera, laser scan, combination of video and dedicated depth sensors, and more. Also, a combination of CGI and real-world data is possible. Examples of representation formats for volumetric data comprise triangle meshes, point clouds, or voxels. Temporal information about the scene can be included in the form of individual capture instances, i.e., “frames” in 2D video, or other means, e.g., position of an object as a function of time.

Because volumetric video describes a 3D scene (or object), such data can be viewed from any viewpoint. Therefore, volumetric video is an important format for any AR, VR or MR applications, especially for providing 6DOF viewing capabilities.

Increasing computational resources and advances in 3D data acquisition devices have enabled reconstruction of highly detailed volumetric video representations of natural scenes. Infrared, lasers, time-of-flight, and structured light are examples of devices that can be used to construct 3D video data. Representation of the 3D data depends on how the 3D data is used. Dense Voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding, this 3D data as set of texture and depth map as is the case in the multi-view plus depth. Closely related to the techniques used in multi-view plus depth is the use of elevation maps, and multi-level surface maps.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for encoding comprising means for receiving a sequence of volumetric video frames comprising a volumetric visual object being defined with a mesh of interconnected vertices; means for selecting one or more reference frames from the sequence of volumetric video frames for a group of pictures; means for clustering a mesh of the one or more reference frames into patches, each patch being associated with a corresponding bounding volume; means for creating matching patches in frames dependent on the reference frame; means for estimating scaling and rotation parameters for each individual patch in the dependent frame; means for applying the estimated scaling and rotation parameters to bounding volume of a patch of the dependent frames; means for packing the patches to an atlas bitstream of a volumetric video stream and means for including into a bitstream the estimated rotation parameter and the estimated scaling parameter alongside the bounding volume of a patch.

According to a second aspect, there is provided an apparatus for decoding, comprising means for receiving an encoded volumetric video bitstream comprising an atlas bitstream; means for decoding from the atlas bitstream patches associated with a corresponding bounding volume; means for decoding from the atlas bitstream information on a scaling parameter and a rotation parameter of a patch; means for creating a mesh from the decoded patches by using information on the scaling parameter and the rotation parameter; and means for reconstructing a volumetric visual object from the created mesh.

According to a third aspect, there is provided a method for encoding, comprising receiving a sequence of volumetric video frames comprising a volumetric visual object being defined with a mesh of interconnected vertices; selecting one or more reference frames from the sequence of volumetric video frames for a group of pictures; clustering a mesh of the one or more reference frames into patches, each patch being associated with a corresponding bounding volume; creating matching patches in frames dependent on the reference frame; estimating scaling and rotation parameters for each individual patch in the dependent frame; applying the estimated scaling and rotation parameters to bounding volume of a patch of the dependent frames; packing the patches to an atlas bitstream of a volumetric video stream and including into a bitstream the estimated rotation parameter and the estimated scaling parameter alongside the bounding volume of a patch.

According to a fourth aspect, there is provided a method for decoding comprising receiving an encoded volumetric video bitstream comprising an atlas bitstream; decoding from the atlas bitstream patches associated with a corresponding bounding volume; decoding from the atlas bitstream information on a scaling parameter and a rotation parameter of a patch; creating a mesh from the decoded patches by using information on the scaling parameter and the rotation parameter; and reconstructing a volumetric visual object from the created mesh.

According to a fifth aspect, there is provided an apparatus for encoding comprising at least one processor, memory including computer program code, the memory and the computer program code configured to, with the at least one processor, cause the apparatus to perform at least the following receive a sequence of volumetric video frames comprising a volumetric visual object being defined with a mesh of interconnected vertices; select one or more reference frames from the sequence of volumetric video frames for a group of pictures; cluster a mesh of the one or more reference frames into patches, each patch being associated with a corresponding bounding volume; create matching patches in frames dependent on the reference frame; estimate scaling and rotation parameters for each individual patch in the dependent frame; apply the estimated scaling and rotation parameters to bounding volume of a patch of the dependent frames; pack the patches to an atlas bitstream of a volumetric video stream and include into a bitstream the estimated rotation parameter and the estimated scaling parameter alongside the bounding volume of a patch.

According to a sixth aspect, there is provided an apparatus for decoding comprising at least one processor, memory including computer program code, the memory and the computer program code configured to, with the at least one processor, cause the apparatus to perform at least the following: receive an encoded volumetric video bitstream comprising an atlas bitstream; decode from the atlas bitstream patches associated with a corresponding bounding volume; decode from the atlas bitstream information on a scaling parameter and a rotation parameter of a patch; create a mesh from the decoded patches by using information on the scaling parameter and the rotation parameter; and reconstruct a volumetric visual object from the created mesh.

According to a seventh aspect, there is provided computer program product comprising computer program code configured to, when executed on at least one processor, cause an apparatus or a system to receive a sequence of volumetric video frames comprising a volumetric visual object being defined with a mesh of interconnected vertices; select one or more reference frames from the sequence of volumetric video frames for a group of pictures; cluster a mesh of the one or more reference frames into patches, each patch being associated with a corresponding bounding volume; create matching patches in frames dependent on the reference frame; estimate scaling and rotation parameters for each individual patch in the dependent frame; apply the estimated scaling and rotation parameters to bounding volume of a patch of the dependent frames; pack the patches to an atlas bitstream of a volumetric video stream and include into a bitstream the estimated rotation parameter and the estimated scaling parameter alongside the bounding volume of a patch.

According to an eighth aspect, there is provided computer program product comprising computer program code configured to, when executed on at least one processor, cause an apparatus or a system to receive an encoded volumetric video bitstream comprising an atlas bitstream; decode from the atlas bitstream patches associated with a corresponding bounding volume; decode from the atlas bitstream information on a scaling parameter and a rotation parameter of a patch; create a mesh from the decoded patches by using information on the scaling parameter and the rotation parameter; and reconstruct a volumetric visual object from the created mesh.

According to an embodiment, for creating temporally consistent patches comprises creating mesh clusters independently for each frame dependent on the reference frame, and finding the most similar cluster in a reference frame for each cluster in the frame dependent on the reference frame.

According to an embodiment, for creating temporally consistent patches comprises creating a skeleton of a mesh facilitating tracking of mesh changes from frame to frame.

According to an embodiment, for creating temporally consistent patches comprises creating multiple reference frames for each group of frames.

According to an embodiment, for creating temporally consistent patches comprises observing whether patches have rotation and/or scaling difference between frames.

According to an embodiment, for creating matching patches from frames dependent on the reference frame comprises clustering frames dependent on the reference frame independently and matching the patches from the dependent frames to the dependent frames.

According to an embodiment, a face from a set of unclustered faces representing the mesh is selected as a starting point for a current cluster, the selected face is selected from the set of unclustered faces, and the selected face is added to the current cluster; a projection normal that has a minimum angular difference to the selected face's normal is determined; if the current face's connected face's normal is closer to the determined projection plane than to any other projection plane normal, the connected face is removed from the set of unclustered faces and the connected face is added to the current cluster; wherein this step is continued with other connected faces that are in the set of unclustered faces until the set of unclustered faces is empty; clusters within a frame are matched to clusters from temporally neighboring frames.

According to an embodiment, for creating matching patches from frames dependent on the reference frame comprises clustering the frames dependent on the reference frame by using clustering information from the reference frame.

According to an embodiment, a mesh eccentricity is estimated for each frame by computing each vertex of a mesh a mean geodesic distance to all other vertices in the mesh, and eccentricities are compared between frames.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a compression process of a volumetric video;

FIG. 2 shows an example of a de-compression of a volumetric video;

FIG. 3a shows an example of a volumetric media conversion at an encoder;

FIG. 3b shows an example of a volumetric media reconstruction at a decoder;

FIG. 4 shows an example of block to patch mapping;

FIG. 5a shows an example of an atlas coordinate system;

FIG. 5b shows an example of a local 3D patch coordinate system;

FIG. 5c shows an example of a final target 3D coordinate system;

FIG. 6 shows a V-PCC extension for mesh encoding;

FIG. 7 shows a V-PCC extension for mesh decoding;

FIG. 8 shows an example of a mesh and UV texture patches of a dynamic mesh;

FIG. 9 shows an example of a mesh eccentricity;

FIG. 10 is a flowchart illustrating a method according to an embodiment;

FIG. 11 is a flowchart illustrating a method according to another embodiment; and

FIG. 12 shown an example of an apparatus

### DESCRIPTION OF EXAMPLE EMBODIMENTS

The present embodiments relate to encoding, signalling, and rendering a volumetric video based on mesh coding. The aim of the present solution is to improve the industry standard for reconstructing mesh surfaces for volumetric video. This specification discloses implementation methods to ensure temporal stabilization of mesh UV textures which in consequence increase compression efficiency of the encoding pipeline.

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure.

In the following, a short reference of ISO/IEC DIS 23090-5 Visual Volumetric Video-based Coding (V3C) and Video-based Point Cloud Compression (V-PCC) 2nd Edition is given. Visual volumetric video comprising a sequence of visual volumetric frames, if uncompressed, may be represented by a large amount of data, which can be costly in terms of storage and transmission. This has led to the need for a high coding efficiency standard for the compression of visual volumetric data.

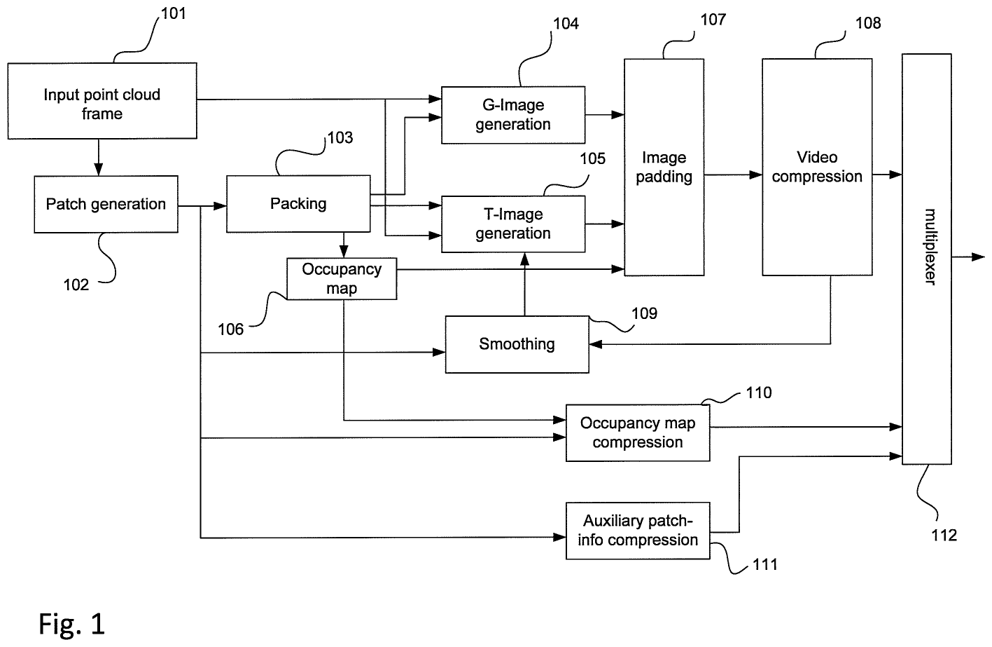

FIG. 1 illustrates an overview of an example of a compression process of a volumetric video. Such process may be applied for example in MPEG Point Cloud Coding (PCC). The process starts with an input point cloud frame 101 that is provided for patch generation 102, geometry image generation 104 and texture image generation 105.

The patch generation 102 process aims at decomposing the point cloud into a minimum number of patches with smooth boundaries, while also minimizing the reconstruction error. For patch generation, the normal at every point can be estimated. An initial clustering of the point cloud can then be obtained by associating each point with one of the following six oriented planes, defined by their normals:
(1.0, 0.0, 0.0),
(0.0, 1.0, 0.0),
(0.0, 0.0, 1.0),
(−1.0, 0.0, 0.0),
(0.0, −1.0, 0.0), and
(0.0, 0.0, −1.0)

More precisely, each point may be associated with the plane that has the closest normal (i.e., maximizes the dot product of the point normal and the plane normal).

The initial clustering may then be refined by iteratively updating the cluster index associated with each point based on its normal and the cluster indices of its nearest neighbors. The final step may comprise extracting patches by applying a connected component extraction procedure.

Patch info determined at patch generation 102 for the input point cloud frame 101 is delivered to packing process 103, to geometry image generation 104 and to texture image generation 105. The packing process 103 aims at mapping the extracted patches onto a 2D plane, while trying to minimize the unused space, and guaranteeing that every TxT (e.g., 16×16) block of the grid is associated with a unique patch. It should be noticed that T may be a user-defined parameter. Parameter T may be encoded in the bitstream and sent to the decoder.

The used simple packing strategy iteratively tries to insert patches into a W×H grid. W and H may be user-defined parameters, which correspond to the resolution of the geometry/texture images that will be encoded. The patch location is determined through an exhaustive search that is performed in raster scan order. The first location that can guarantee an overlapping-free insertion of the patch is selected and the grid cells covered by the patch are marked as used. If no empty space in the current resolution image can fit a patch, then the height H of the grid may be temporarily doubled, and search is applied again. At the end of the process, H is clipped so as to fit the used grid cells.

The geometry image generation 104 and the texture image generation 105 are configured to generate geometry images and texture images respectively. The image generation process may exploit the 3D to 2D mapping computed during the packing process to store the geometry and texture of the point cloud as images. In order to better handle the case of multiple points being projected to the same pixel, each patch may be projected onto two images, referred to as layers. For example, let H(u, y) be the set of points of the current patch that get projected to the same pixel (u, v). The first layer, also called a near layer, stores the point of H(u, v) with the lowest depth D0. The second layer, referred to as the far layer, captures the point of H(u, v) with the highest depth within the interval [D0, D0+4Δ], where Δ is a user-defined parameter that describes the surface thickness. The generated videos may have the following characteristics:
Geometry: WxH YUV420-8 bit,
Texture: WxH YUV420-8 bit,

It is to be noticed that the geometry video is monochromatic. In addition, the texture generation procedure exploits the reconstructed/smoothed geometry in order to compute the colors to be associated with the re-sampled points.

The geometry images and the texture images may be provided to image padding 107. The image padding 107 may also receive as an input an occupancy map (OM) 106 to be used with the geometry images and texture images. The occupancy map 106 may comprise a binary map that indicates for each cell of the grid whether it belongs to the empty space or to the point cloud. In other words, the occupancy map (OM) may be a binary image of binary values where the occupied pixels and non-occupied pixels are distinguished and depicted respectively. The occupancy map may alternatively comprise a non-binary image allowing additional information to be stored in it. Therefore, the representative values of the DOM (Deep Occupancy Map) may comprise binary values or other values, for example integer values. It should be noticed that one cell of the 2D grid may produce a pixel during the image generation process. Such an occupancy map may be derived from the packing process 103.

The padding process 107 aims at filling the empty space between patches in order to generate a piecewise smooth image suited for video compression. For example, in a simple padding strategy, each block of T×T (e.g., 16×16) pixels is compressed independently. If the block is empty (i.e., unoccupied, i.e., all its pixels belong to empty space), then the pixels of the block are filled by copying either the last row or column of the previous T×T block in raster order. If the block is full (i.e., occupied, i.e., no empty pixels), nothing is done. If the block has both empty and filled pixels (i.e., edge block), then the empty pixels are iteratively filled with the average value of their non-empty neighbors.

The padded geometry images and padded texture images may be provided for video compression 108. The generated images/layers may be stored as video frames and compressed using for example the HM16.16 video codec according to the HM configurations provided as parameters. The video compression 108 also generates reconstructed geometry images to be provided for smoothing 109, wherein a smoothed geometry is determined based on the reconstructed geometry images and patch info from the patch generation 102. The smoothed geometry may be provided to texture image generation 105 to adapt the texture images.

The patch may be associated with auxiliary information being encoded/decoded for each patch as metadata. The auxiliary information may comprise index of the projection plane, 2D bounding volume, for example a bounding box, 3D location of the patch.

For example, the following metadata may be encoded/decoded for every patch:
index of the projection plane
   Index 0 for the planes (1.0, 0.0, 0.0) and (−1.0, 0.0, 0.0)
   Index 1 for the planes (0.0, 1.0, 0.0) and (0.0, −1.0, 0.0)
   Index 2 for the planes (0.0, 0.0, 1.0) and (0.0, 0.0, −1.0)
2D bounding box (u0, v0, u1, v1)
3D location (x0, y0, z0) of the patch represented in terms of depth 60, tangential shift s0 and bitangential shift r0. According to the chosen projection planes, (δ0, s0, r0) may be calculated as follows:
   Index 0, δ0=x0, s0=z0 and r0=y0
   Index 1, δ0=y0, s0=z0 and r0=x0
   Index 2, δ0=z0, s0=x0 and r0=y0

Also, mapping information providing for each T×T block its associated patch index may be encoded as follows:
For each T×T block, let L be the ordered list of the indexes of the patches such that their 2D bounding box contains that block. The order in the list is the same as the order used to encode the 2D bounding boxes. L is called the list of candidate patches.
The empty space between patches is considered as a patch and is assigned the special index 0, which is added to the candidate patches list of all the blocks.
Let I be index of the patch, which the current T×T block belongs to, and let J be the position of I in L. Instead of explicitly coding the index I, its position J is arithmetically encoded instead, which leads to better compression efficiency.

The occupancy map consists of a binary map that indicates for each cell of the grid whether it belongs to the empty space or to the point cloud. One cell of the 2D grid produces a pixel during the image generation process.

The occupancy map compression 110 leverages the auxiliary information described in previous section, in order to detect the empty T×T blocks (i.e., blocks with patch index 0). The remaining blocks may be encoded as follows: The occupancy map can be encoded with a precision of a B0×B0 blocks. B0 is a configurable parameter. In order to achieve lossless encoding, B0 may be set to 1. In practice B0=2 or B0=4 results in visually acceptable results, while significantly reducing the number of bits required to encode the occupancy map.

The compression process may comprise one or more of the following example operations:
Binary values may be associated with B0×B0 sub-blocks belonging to the same T×T block. A value 1 associated with a sub-block, if it contains at least a non-padded pixel, and 0 otherwise. If a sub-block has a value of 1 it is said to be full, otherwise it is an empty sub-block.
If all the sub-blocks of a T×T block are full (i.e., have value 1). The block is said to be full. Otherwise, the block is said to be non-full.
A binary information may be encoded for each T×T block to indicate whether it is full or not.
If the block is non-full, an extra information indicating the location of the full/empty sub-blocks may be encoded as follows:
Different traversal orders may be defined for the sub-blocks, for example horizontally, vertically, or diagonally starting from top right or top left corner
The encoder chooses one of the traversal orders and may explicitly signal its index in the bitstream.
The binary values associated with the sub-blocks may be encoded by using a run-length encoding strategy.
   The binary value of the initial sub-block is encoded.
   Continuous runs of 0s and 1s are detected, while following the traversal order selected by the encoder.
   The number of detected runs is encoded.
   The length of each run, except of the last one, is also encoded.

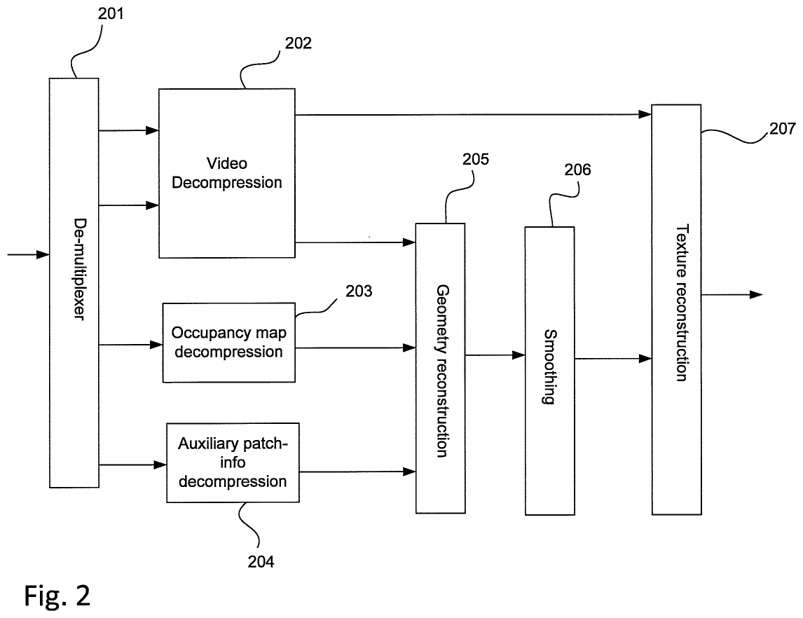

FIG. 2 illustrates an overview of a de-compression process for MPEG Point Cloud Coding (PCC). A de-multiplexer 201 receives a compressed bitstream, and after de-multiplexing, provides compressed texture video and compressed geometry video to video decompression 202. In addition, the de-multiplexer 201 transmits compressed occupancy map to occupancy map decompression 203. It may also transmit a compressed auxiliary patch information to auxiliary patch-info compression 204. Decompressed geometry video from the video decompression 202 is delivered to geometry reconstruction 205, as are the decompressed occupancy map and decompressed auxiliary patch information. The point cloud geometry reconstruction 205 process exploits the occupancy map information in order to detect the non-empty pixels in the geometry/texture images/layers. The 3D positions of the points associated with those pixels may be computed by leveraging the auxiliary patch information and the geometry images.

The reconstructed geometry image may be provided for smoothing 206, which aims at alleviating potential discontinuities that may arise at the patch boundaries due to compression artifacts. The implemented approach moves boundary points to the centroid of their nearest neighbors. The smoothed geometry may be transmitted to texture reconstruction 207, which also receives a decompressed texture video from video decompression 202. The texture reconstruction 207 outputs a reconstructed point cloud. The texture values for the texture reconstruction are directly read from the texture images.

The point cloud geometry reconstruction process exploits the occupancy map information in order to detect the non-empty pixels in the geometry/texture images/layers. The 3D positions of the points associated with those pixels are computed by levering the auxiliary patch information and the geometry images. More precisely, let P be the point associated with the pixel (u, v) and let (δ0, s0, r0) be the 3D location of the patch to which it belongs and (u0, v0, u1, v1) its 2D bounding box. P can be expressed in terms of depth δ(u, v), tangential shift s(u, v) and bi-tangential shift r(u, v) as follows:

δ(u,v)=δ0+g(u,v)

s(u,v)=s0−u0+u

r(u,v)=r0−v0+v

where g(u, v) is the luma component of the geometry image.

For the texture reconstruction, the texture values can be directly read from the texture images. The result of the decoding process is a 3D point cloud reconstruction.

Visual volumetric video-based Coding (V3C) relates to a core part shared between ISO/IEC 23090-5 (formerly V-PCC (Video-based Point Cloud Compression)) and ISO/IEC 23090-12 (formerly MIV (MPEG Immersive Video)). V3C will not be issued as a separate document, but as part of ISO/IEC 23090-5 (expected to include clauses 1-8 of the current V-PCC text). ISO/IEC 23090-12 will refer to this common part. ISO/IEC 23090-5 will be renamed to V3C PCC, ISO/IEC 23090-12 renamed to V3C MIV.

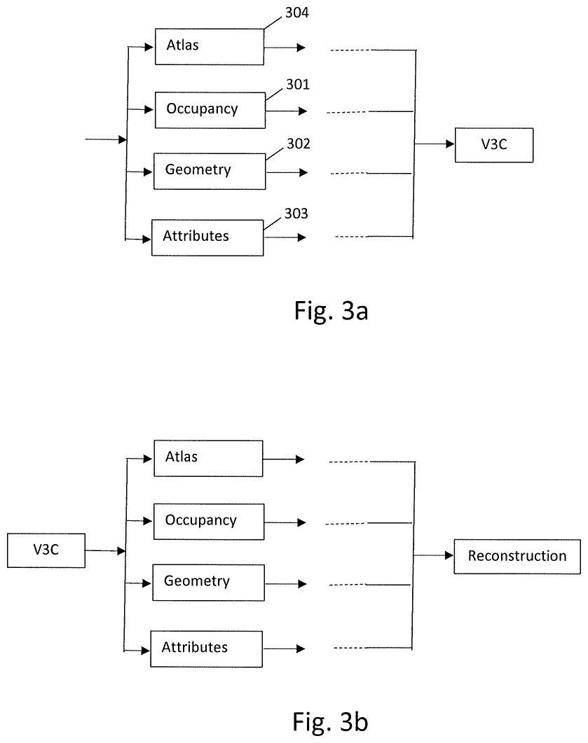

V3C enables the encoding and decoding processes of a variety of volumetric media by using video and image coding technologies. This is achieved through first a conversion of such media from their corresponding 3D representation to multiple 2D representations, also referred to as V3C video components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g., texture or material information, of such 3D data. An example is shown in FIGS. 3a and 3b, where FIG. 3a presents volumetric media conversion at an encoder, and where FIG. 3b presents volumetric media reconstruction at a decoder side. The 3D media is converted to a series of 2D representations: occupancy 301, geometry 302, and attributes 303. Additional information may also be included in the bitstream to enable inverse reconstruction.

Additional information that allows associating all these V3C video components, and enables the inverse reconstruction from a 2D representation back to a 3D representation is also included in a special component, referred to in this document as the atlas 304. An atlas 304 consists of multiple elements, named as patches. Each patch identifies a region in all available 2D components and contains information necessary to perform the appropriate inverse projection of this region back to the 3D space. The shape of such regions is determined through a 2D bounding volume associated with each patch as well as their coding order. The shape of these regions is also further refined after the consideration of the occupancy information.

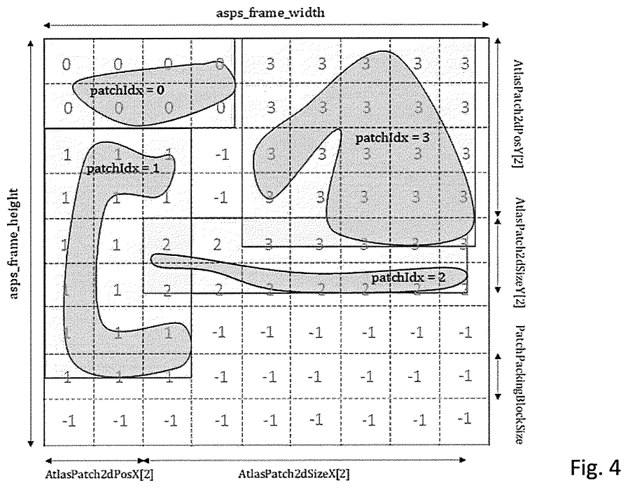

Atlases may be partitioned into patch packing blocks of equal size. The 2D bounding volumes of patches and their coding order determine the mapping between the blocks of the atlas image and the patch indices. FIG. 4 shows an example of block to patch mapping with 4 projected patches onto an atlas when asps_patch_precedence_order_flag is equal to 0. Projected points are represented with dark grey. The area that does not contain any projected points is represented with light grey. Patch packing blocks are represented with dashed lines. The number inside each patch packing block represents the patch index of the patch to which it is mapped.

Axes orientations are specified for internal operations. For instance, the origin of the atlas coordinates is located on the top-left corner of the atlas frame. For the reconstruction step, an intermediate axes definition for a local 3D patch coordinate system is used. The 3D local patch coordinate system is then converted to the final target 3D coordinate system using appropriate transformation steps.

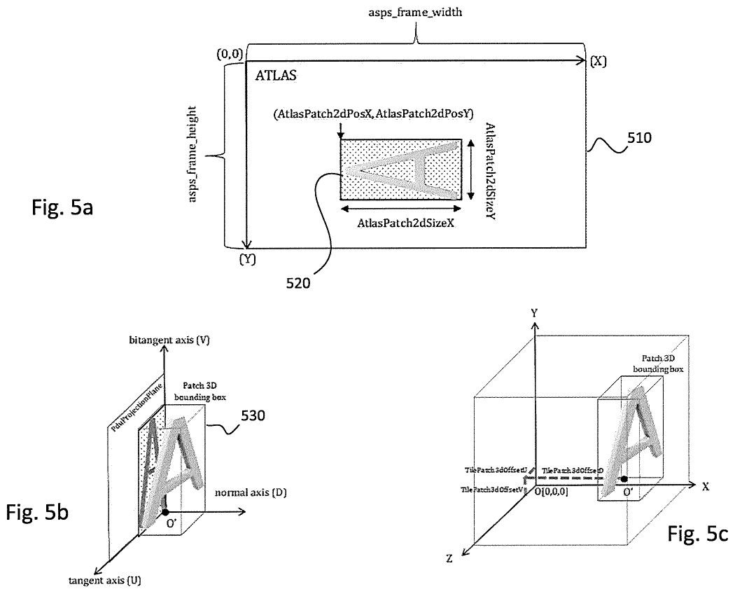

FIG. 5a shows an example of a single patch 520 packed onto an atlas image 510. This patch 520 is then converted to a local 3D patch coordinate system (U, V, D) defined by the projection plane with origin O′, tangent (U), bi-tangent (V), and normal (D) axes. For an orthographic projection, the projection plane is equal to the sides of an axis-aligned 3D bounding volume 530, as shown in FIG. 5b. The location of the bounding volume 530 in the 3D model coordinate system, defined by a left-handed system with axes (X, Y, Z), can be obtained by adding offsets TilePatch3dOffsetU, TilePatch3DOffsetV, and TilePatch3DOffsetD, as illustrated in FIG. 5c.

Coded V3C video components are referred to in this disclosure as video bitstreams, while a coded atlas is referred to as the atlas bitstream. Video bitstreams and atlas bitstreams may be further split into smaller units, referred to here as video and atlas sub-bitstreams, respectively, and may be interleaved together, after the addition of appropriate delimiters, to construct a V3C bitstream.

V3C patch information is contained in atlas bitstream, atlas_sub_bitstream( ) which contains a sequence of NAL units. NAL unit is specified to format data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex D of ISO/IEC 23090-5 each NAL unit can be preceded by an additional element that specifies the size of the NAL unit.

NAL units in atlas bitstream can be divided to atlas coding layer (ACL) and non-atlas coding layer (non-ACL) units. The former dedicated to carry patch data while the later to carry data necessary to properly parse the ACL units or any additional auxiliary data.

In the nal_unit_header( ) syntax nal_unit_type specifies the type of the RBSP data structure contained in the NAL unit as specified in Table 4 of ISO/IEC 23090-5. nal_layer_id specifies the identifier of the layer to which an ACL NAL unit belongs or the identifier of a layer to which a non-ACL NAL unit applies. The value of nal_layer_id shall be in the range of 0 to 62, inclusive. The value of 63 may be specified in the future by ISO/IEC. Decoders conforming to a profile specified in Annex A of ISO/IEC 23090-5 shall ignore (i.e., remove from the bitstream and discard) all NAL units with values of nal_layer_id not equal to 0.

rbsp_byte[i] is the i-th byte of an RBSP. An RBSP is specified as an ordered sequence of bytes as follows:

The RBSP contains a string of data bits (SODB) as follows:
If the SODB is empty (i.e., zero bits in length), the RBSP is also empty.
Otherwise, the RBSP contains the SODB as follows:
   The first byte of the RBSP contains the first (most significant, left-most) eight bits of the SODB; the next byte of the RBSP contains the next eight bits of the SODB, etc., until fewer than eight bits of the SODB remain.
   The rbsp_trailing_bits( ) syntax structure is present after the SODB as follows:
      The first (most significant, left-most) bits of the final RBSP byte contain the remaining bits of the SODB (if any).
      The next bit consists of a single bit equal to 1 (i.e., rbsp_stop_one_bit).
      When the rbsp_stop_one_bit is not the last bit of a byte-aligned byte, one or more bits equal to 0 (i.e., instances of rbsp_alignment_zero_bit) are present to result in byte alignment.

One or more cabac_zero_word 16-bit syntax elements equal to 0x0000 may be present in some RBSPs after the rbsp_trailing_bits( ) at the end of the RBSP.

Syntax structures having these RBSP properties are denoted in the syntax tables using an “_rbsp” suffix. These structures are carried within NAL units as the content of the rbsp_byte[i] data bytes. As an example, the following may be considered as typical content:
atlas_sequence_parameter_set_rbsp( ) which is used to carry parameters related to atlas on a sequence level.
atlas_frame_parameter_set_rbsp( ) which is used to carry parameters related to atlas on a frame level and are valid for one or more atlas frames.
sei_rbsp( ) used to carry SEI messages in NAL units.
atlas_tile_group_layer_rbsp( ) used to carry patch layout information for tile groups.

When the boundaries of the RBSP are known, the decoder can extract the SODB from the RBSP by concatenating the bits of the bytes of the RBSP and discarding the rbsp_stop_one_bit, which is the last (least significant, right-most) bit equal to 1, and discarding any following (less significant, farther to the right) bits that follow it, which are equal to 0. The data necessary for the decoding process is contained in the SODB part of the RBSP.

atlas_tile_group_laye_rbsp( ) contains metadata information for a list off tile groups, which represent sections of frame. Each tile group may contain several patches for which the metadata syntax is described below.

| | Descriptor |
|---|---|
| patch_data_unit( patchIdx ) { | |
| pdu_2d_pos_x[ patchIdx ] | u(v) |
| pdu_2d_pos_y[ patchIdx ] | u(v) |
| pdu_2d_delta_size_x[ patchIdx ] | se(v) |
| pdu_2d_delta_size_y[ patchIdx ] | se(v) |
| pdu_3d_pos_x[ patchIdx ] | u(v) |
| pdu_3d_pos_y[ patchIdx ] | u(v) |
| pdu_3d_pos_min_z[ patchIdx ] | u(v) |
| if( asps_normal_axis_max_delta_value_enabled_flag ) | |
| pdu_3d_pos_delta_max_z [ patchIdx ] | u(v) |
| pdu_projection_id[ patchIdx ] | u(v) |
| pdu_orientation_index[ patchIdx ] | u(v) |
| if( afps_lod_mode_enabled_flag ) { | |
| pdu_lod_enabled_flag [ patchIndex ] | u(1) |
| if( pdu_lod_enabled_flag[ patchIndex ] > 0 ) { | |
| pdu_lod_scale_x_minus1[ patchIndex] | ue(v) |
| pdu_lod_scale_y[ patchIndex ] | ue(v) |
| } | |
| } | u(v) |
| if( asps_point_local_reconstruction_enabled_flag ) | |
| point_local_reconstruction_data(patchIdx ) | |
| } | |

Annex F of V3C V-PCC specification (23090-5) describes different SEI messages that have been defined for V3C MIV purposes. SEI messages assist in processes related to decoding, reconstruction, display, or other purposes. Annex F (23090-5) defines two types of SEI messages: essential and non-essential. V3C SEI messages are signaled in sei_rspb( ) which is documented below.

Descriptor

```
sei_rbsp( ) {
  do
    sei_message( )
  while( more_rbsp_data( ) )
  rbsp_trailing_bits( )
}
```

Non-essential SEI messages are not required by the decoding process. Conforming decoders are not required to process this information for output order conformance.

Specification for presence of non-essential SEI messages is also satisfied when those messages (or some subset of them) are conveyed to decoders (or to the HRD) by other means not specified in V3C V-PCC specification (23090-5). When present in the bitstream, non-essential SEI messages shall obey the syntax and semantics as specified in Annex F (23090-5). When the content of a non-essential SEI message is conveyed for the application by some means other than presence within the bitstream, the representation of the content of the SEI message is not required to use the same syntax specified in annex F (23090-5). For the purpose of counting bits, only the appropriate bits that are present in the bitstream are counted.

Essential SEI messages are an integral part of the V3C bitstream and should not be removed from the bitstream. The essential SEI messages are categorized into two types:
Type-A essential SEI messages: These SEls contain information required to check bitstream conformance and for output timing decoder conformance. Every V3C decoder conforming to point A should not discard any relevant Type-A essential SEI messages and shall consider them for bitstream conformance and for output timing decoder conformance.
Type-B essential SEI messages: V3C decoders that wish to conform to a particular reconstruction profile should not discard any relevant Type-B essential SEI messages and shall consider them for 3D point cloud reconstruction and conformance purposes.

A polygon mesh is a collection of vertices, edges and faces that defines the shape of a polyhedral object in 3D computer graphics and solid modelling. The faces usually consist of triangles (triangle mesh), quadrilaterals (quads), or other simple convex polygons (n-gons), since this simplifies rendering, but may also be more generally composed of concave polygons, or even polygons with holes. Objects created with polygon meshes are represented by different types of elements. These include vertices, edges, faces, polygons, and surfaces. In many applications, only vertices, edges and either faces or polygons are stored.

Polygon meshes are defined by the following elements:
Vertex: A position in 3D space defined as (x, y, z) along with other information such as color (r, g, b), normal vector and texture coordinates.
Edge: A connection between two vertices.
Face: A closed set of edges, in which a triangle face has three edges, and a quad face has four edges. A polygon is a coplanar set of faces. In systems that support multi-sided faces, polygons and faces are equivalent. Mathematically a polygonal mesh may be considered an unstructured grid, or undirected graph, with additional properties of geometry, shape and topology.
Surfaces: or smoothing groups, are useful, but not required to group smooth regions.
Groups: Some mesh formats contain groups, which define separate elements of the mesh, and are useful for determining separate sub-objects for skeletal animation or separate actors for non-skeletal animation.
Materials: defined to allow different portions of the mesh to use different shaders when rendered.
UV coordinates: Most mesh formats also support some form of UV coordinates which are a separate 2D representation of the mesh “unfolded” to show what portion of a 2-dimensional texture map applies to different polygons of the mesh. It is also possible for meshes to contain other vertex attribute information such as color, tangent vectors, weight maps to control animation, etc. (sometimes also called channels).

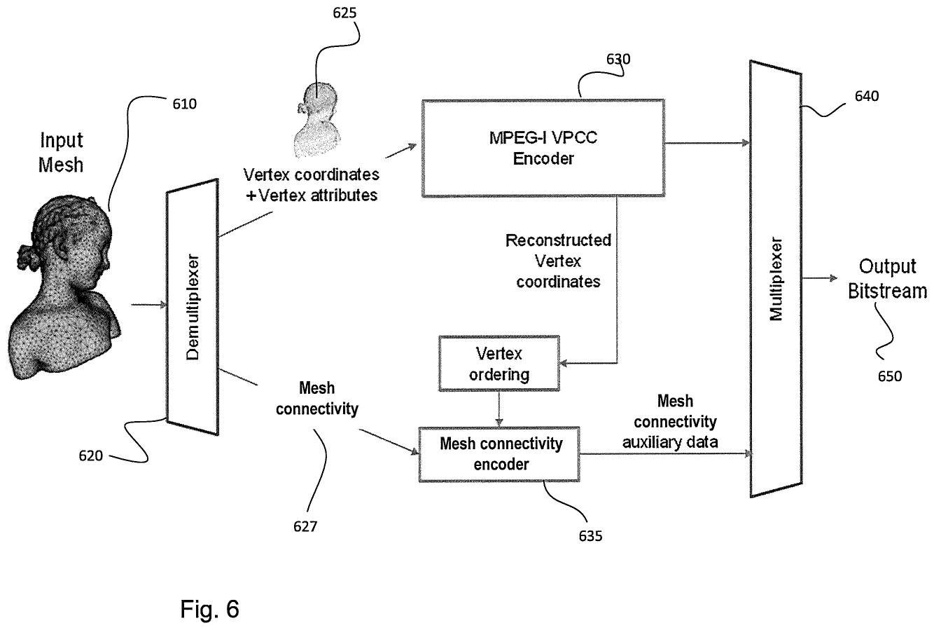

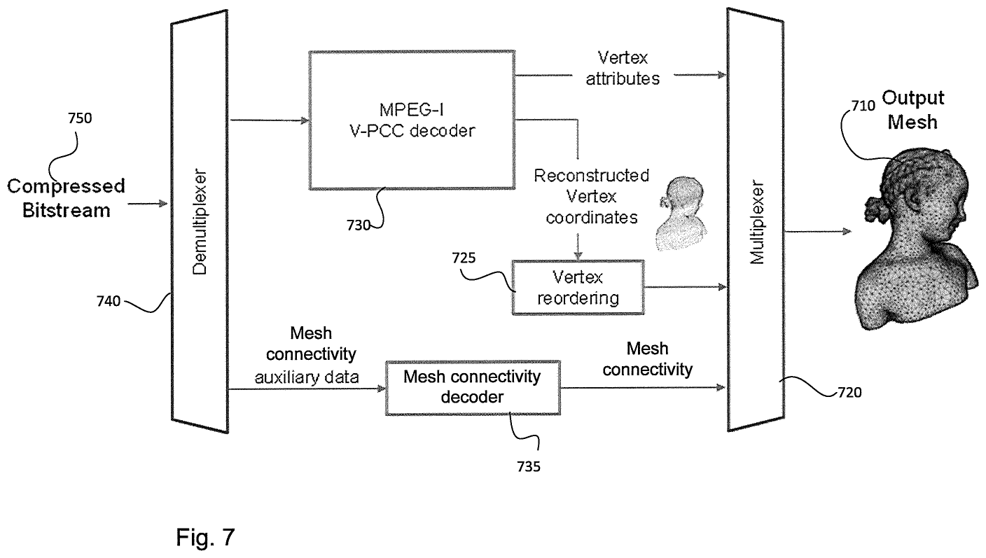

FIG. 6 and FIG. 7 show the extensions to the V3C encoder and decoder to support mesh encoding and mesh decoding.

In the encoder extension, shown in FIG. 6, the input mesh data 610 is demultiplexed 620 into vertex coordinate and attributes data 625 and mesh connectivity 627, where the mesh connectivity comprises vertex connectivity information. The vertex coordinate and attributes data 625 is coded using MPEG-I V-PCC 630 (such as shown in FIG. 1), whereas the mesh connectivity data 627 is coded in mesh connectivity encoder 635 as auxiliary data. Both of these are multiplexed 640 to create the final compressed output bitstream 650. Vertex ordering is carried out on the reconstructed vertex coordinates at the output of MPEG-I V-PCC to reorder the vertices for optimal mesh connectivity encoding.

At the decoder, shown in FIG. 7, the input bitstream 750 is demultiplexed 740 to generate the compressed bitstreams for vertex coordinates and attributes data and mesh connectivity. The vertex coordinates and attributes data are decompressed using MPEG-I V-PCC decoder 730. Vertex reordering 725 is carried out on the reconstructed vertex coordinates at the output of MPEG-I V-PCC decoder 730 to match the vertex order at the encoder. Mesh connectivity data is decompressed using mesh connectivity decoder 735. The decompressed data is multiplexed 720 to generate the reconstructed mesh 710.

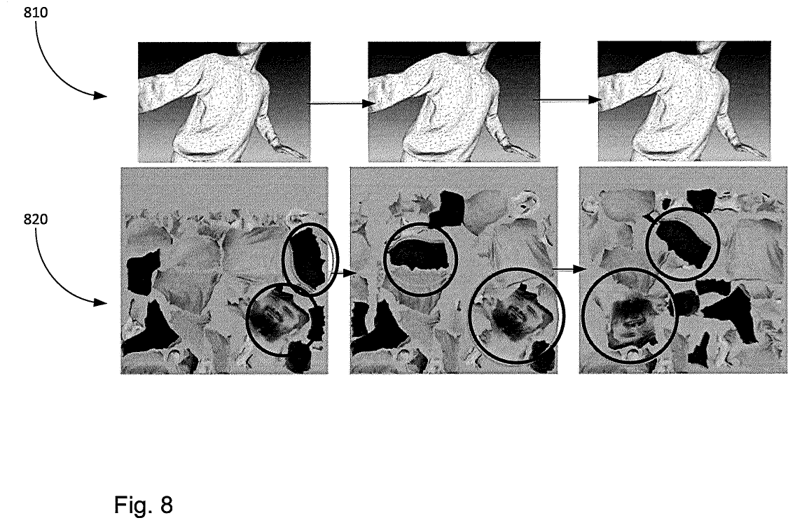

MPEG 3DG (ISO/IEC SC 29 WG7) is planning to issue call for proposal (CfP) on integration of MESH compression into the V3C family of standards (ISO/IEC 23090-5). The present embodiments are based on discovery that mesh texture contributes the majority of bitrate in the compressed stream. Depending on the input material, patch arrangement and patches themselves change significantly between frames. FIG. 8 shows an example of a mesh 810 and UV texture patches 820 of a dynamic mesh. What should be noticed from the sequence of UV texture patches 820 is that some patches (circled) change their position and orientation. The current video encoders exploit temporal redundancies between frames to reduce bitrate. With the current, uncontrolled patch arrangement, significant inter-frame compression potential remains unused.

The present embodiments relate to methods for temporal stabilization of mesh UV textures. It is achieved by creating (nearly) time-consistent triangle subsets (clusters) of the triangle set in each frame and packing these projected clusters (patches) in a spatially consistent way over multiple frames.

Encoder

The encoder according to an embodiment may comprise the following:
A mesh-compression framework (MCF)
   According to an embodiment, MCF can be used with projection-based mesh coding;
   According to another embodiment, MCF can be used only to stabilize UV textures, after which mesh compression can be performed by using a 2D video codec for texture in addition to, e.g., Google Draco/edgrebreaker for topology.
Temporally consistent cluster creation
   According to an embodiment, the encoder may create mesh clusters independently for each frame, and find for each cluster in a frame, the most similar cluster in a reference frame, where the measure of similarity is an input to the encoder.
   According to another embodiment, the encoder may create a skeleton of a mesh that facilitates tracking of mesh changes from frame to frame and consequently aids tracking corresponding triangle clusters in each frame.
   According to another embodiment, multiple reference frames are created for each group of frames (also referred to as “group of pictures” GoP), to provide efficient compression for unpredictable content changes.
   According to another embodiment, the following is observed: patches may have slight rotation and scaling differences between frames, which is compensated by the encoder (it applies reverse rotation and scaling to achieve similar patches) to improve video compression of the packed patches.

The present solution is about a method that allows to temporally stabilize the position of patches (cluster of textured triangles projected into 2D). The patches have been packed within a texture frame to improve inter frame prediction performed by video coding tools. Temporally stable (consistent over multiple frames) packing of temporally matched patches of the same or nearly the same size can be performed by well-known methods. The present solution improves the technology by providing a way to create temporally matches triangle clusters (i.e., patches) from a mesh.

Patch Requirements

For efficient use in mesh coding, the following is expected from each patch:
Patches at one point in time are created in such a way that they have
   constant or nearly constant number of triangles (faces), or
   constant or nearly constant area in 3D space (to compensate for varying vertex density), or
   constant or nearly constant area UV space (to compensate for varying vertex density).
The absolute patch size is a result of a tradeoff:
   on one hand, big patches result in fewer cumulative patch borders, which allows for better compression;
   on the other hand, big patches constrain packing options, limiting compression efficiency.
A patch should have a simple convex shape in the UV texture and in the projected space, enabling efficient packing.

Single Reference Frame Clustering

According to an embodiment, the method comprises defining a reference frame for one Group of Pictures (GoP). The reference frame can be the first or the middle frame of a GoP, or it can be determined by using any suitable method, for example a keyframe prediction method. Then, the method according to the embodiment comprises clustering a mesh from the reference frame into patches, conforming to the requirements presented is paragraph above “Patch requirements”.

Given a clustered reference frame, the method comprises alternative ways to create matched clusters of dependent frames:
1) clustering the dependent frames independently but following similar logic that will yield similar clusters, then matching the clusters from the dependent frames to the reference frames; or
2) clustering the dependent frames using the clustering information from the reference frame.

These alternatives are discussed in more detailed manner in the following:

1) Independent frame clustering and matching

Given the set of frames, for each frame, the method comprises subdividing the mesh into clusters without using clustering information from other frames. This can be done with the following algorithm:
i) Given a set of unclustered faces F that represent the entire mesh, and a set of possible 3D projection plane normals (e.g., the three-unit vectors plus their negatives);
ii) Selecting a random face from F as starting point for the current cluster, remove it from F, add it to the current cluster C₁;
iii) Determining the projection plane normal n that has the minimum angular difference to the selected face's normal;
iv) Recursing into the current face's connected faces:
   a. if the connected face's normal is closer to n (in terms of angle) than to any other projection plane normal:
      i. remove it from F, add it to C₁
      ii. recurse into its connected faces that are still in F
   b. else: do nothing with this face
v) if F is not empty go to ii);
vi) All faces have been assigned to clusters C₁.

This approach may have advantages. For example, the approach enables parallelism, as frames are treated independently. Despite independent processing, the approach creates similar patches between frames, if the meshes between the frames are similar.

The clustering approach can be extended to prefer simple cluster shapes over complex ones, and cluster size can be limited, following the requirements presented is paragraph above “Patch requirements”. Cluster size can be defined as the number of faces, the cluster's area in 3D space, or the cluster's area in UV space, or a combination of these.

After clustering, clusters within one frame must be matched to clusters from temporally neighboring frames. To match the cluster sets from two frames, the following cluster features can be considered:
(motion compensated) 3D vertex positions, yielding a mean cluster position;
Cluster size (number of faces, area);
Texture attribute features, e.g., extracted by ORB/SURF/SIFT.

Matching can then be performed by e.g., a simple nearest neighbor assignment in the feature space. Given the matched clusters, the reference frame's clusters are packed into a frame, and dependent frames are packed using the packing information from the reference.

Alternatively, to starting with a random face in step ii) of the algorithm, the algorithm can search for better initial faces, such as the face whose normal is best aligned to a projection plane normal and surrounded by faces with similar normals.

2) Dependent Frame Clustering

The clustering can be made alternatively on several frames in a dependent manner. One way to achieve this is to perform matching and motion compensation of clusters. Another way to achieve this is to perform a mesh segmentation that is inherently robust to motion. Mainly two types of approaches are possible: semantic based approaches such as mesh joint segmentation and labelling; or geometry-based approaches. The present solution is targeted to skeletonization.

The skeletonization of a mesh consists in building a graph (so-called “skeleton”) that represents the mesh topology combined with a very coarse geometry. A skeleton S(K, E) may be represented as a set of nodes or knots K and a set of edges E connecting them. Estimating the skeleton of a mesh for each frame and matching them together comes with the following advantages:
it can be used to detect whether the mesh topology is stable between frames (e.g., person with a basketball that can be connected to the hands or not from frame to frame);
it can be used to detect whether mesh parts change of projection plane due to motion;
it can be used to track motion by tracking corresponding nodes of the skeleton;
it may be well-suited for star-shaped meshes but is also applicable to meshes that include several disconnected parts.

Among existing skeletonization estimation approaches, one can list voxel-based extraction of skeletons constrained Laplacian thinning of meshes. The present embodiments use a robust approach that consists in estimating the mesh eccentricity by computing for each vertex of the mesh, the mean geodesic distance (using the well-known Dijkstra algorithm for example) to all other vertices in the mesh. Computations can be accelerated by using the vertices of a simplified version of the mesh with little quality reduction.

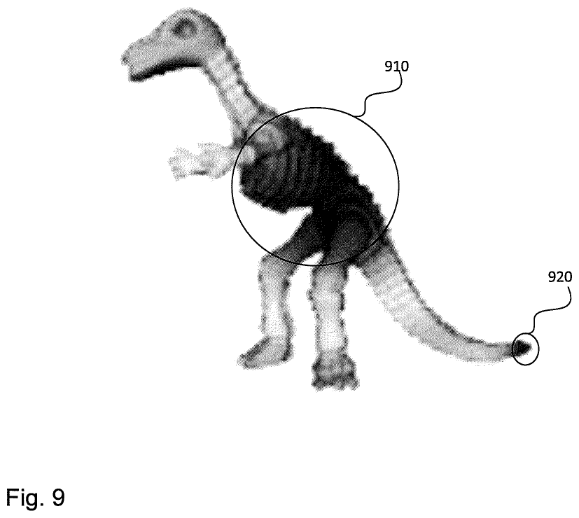

The extremities of the mesh can be found as the vertices for which this mean geodesic distance is locally maximal. Vertices for which the eccentricity is minimal may form a large region called the “core” of the mesh. Mesh eccentricity can be indicated with varying colors, for example core can be indicated with color red, whereas extreme values of the eccentricity can be indicated with color blue. FIG. 9 illustrates an example of mesh eccentricity with a grayscale image. A circled area 910 refers to the core, and a circled area 920 refers to the extreme values of the eccentricity. It is to be noticed that the eccentricity values are invariant to rigid motion and that the eccentricity value of an extreme point can be used as feature to match skeletons from frame to frame.

A first basic skeleton can be obtained by setting a knot at each extreme vertex and one at the center of gravity of the core region, and connecting each extreme knot with the core knot. However, this tads to an extremely coarse and star-shaped graph that will not be useful for motion tracking because of its lack of detail.

One way to retrieve a more detailed skeleton is to first quantize the eccentricity values into K bins from the minimal (core) eccentricity value to the maximum eccentricity value observed. Once such bins are defined, the knots at the extremes of the mesh are defined (local maxima of the mesh eccentricity) and region growing starting from each of these knows is used in a similar way as level sets: connected vertices are added if their eccentricity is within the same quantized bin. When no more connected vertices can be added to this region with the same eccentricity bin, a new region is created and grown with the next eccentricity bin such that no other vertices can be added. A knot is then defined as the center of gravity of that region and connected to the knot of the previous region. This process is repeated until the core region is met, for which a knot is defined at its center of gravity.

More precisely, if the set of extreme vertices is P and the eccentricity bins are noted X[b] with b between 0 and N, with X[0] corresponding to the quantized core eccentricity value and X[N] the maximum observed quantized eccentricity value, S(K, E) is the skeleton to be estimated with K the set of knots and E the set of edges connecting them, V is the set of vertices of the mesh M.
Initialization: V contains all vertices of the mesh, K and E are empty
   For each vertex v in V for which the quantized eccentricity belongs to X[0], remove v from V and add v to the core region noted R[c][0], insert a knot k_core_0 in K with the coordinates of k_core_0 being set as the center of gravity of the vertices in R[c][0]
Start from extremes:
   For each extreme point p in P,
   Initialize a region R[p][pb], where pb corresponds to the eccentricity bin X[pb] of p
   Add a knot k_p_pb to K with coordinates being the same as those of p, and remove p from V
   Iteratively
      Grow R[p][pb] starting from p by adding connected vertices v that are in V for which the eccentricity value is within the same bin X[pb], remove v from V,
      Until there is no more connected vertex v from V that can satisfy the above condition
   Set n to 0, define a new region R[p][pb-n-1], where pb-n-1 is the next bin
      If pb-n-1 is not equal to zero, and V is not empty,
         grow the region R[p][pb-n-1] recursively from the border of the Region R[p][pb-n] by adding connected vertices v that are in V for which the eccentricity value is within the same bin X[pb-n-1], remove v from V
         Until there is no more connected vertex v from V that can satisfy the above condition
         Define a knot k_p_pb-n-1 as the center of gravity or vertices in R[p][pb-n-1], add it to K, connect k_p_pb-n to k_p_pb-n-1, and add this edge to E
         Increment n
      Otherwise
         connect the knot k_p_pb-n-1 to core knot k_c_0 and add this edge to E, stop process for p
Finalize the skeleton S by including knots K and edges E sets in it.

The regions R[p][ . . . ] as well as the core R[c][0] provide a vertex segmentation of the mesh. However, the regions may have dome or cylindrical shapes which are not optimal for patches that use orthographic projection. The process of “Independent frame clustering and matching” can be reused for the corresponding faces of these regions, which will split the cylinder shapes into parts that are more oriented towards unit normal, for example.

One exception case should have been dealt with in case where the shape has one or several handles (for example a basketball player holds a ball with two hands). That can be detected by checking whether the mesh genus is larger than zero (further discussed with respect to following paragraph “Multiple reference frame clustering”). In this case it is possible that the algorithm above creates several disconnected cylinder shapes. This can be detected by checking the region number of connected components (definition is given in following paragraph “Multiple reference frame clustering”), and requires duplicating the knot that would have been assigned to that region into as many knots as there are different connected components. Such knots should be connected by an edge to the knot corresponding to the previous region's knot in the region growing propagation. The recursive region growing should the proceed towards the core starting from the different new knots independently such that skeleton edges remain inside the volume of the mesh. It is then also possible that the growing region re-joins after the handle into a single connected region and a single new knot. In that case, based on our algorithm above, one or several knots will not be able to propagate further towards the core. It is possible to test if such knots can be rejoined to the new knot in the propagation process from the same extreme point by checking if the corresponding regions are connected.

Once skeletons and regions have been generated for each frame, one can match extremities and core knots from frame to frame by comparing their eccentricity as well as their 3D positions (nearest neighbor, possible motion compensation). Once this is done, the remainder of the knots of the two consecutive frame skeletons can be easily mapped to each other, as well as their corresponding regions.

The quality of the skeletons will depend on the quantization of the eccentricity: a small number of bins may sound more efficient for motion tracking, etc., but a larger number of bins enables to have sufficient knots and that the resulting skeleton edges remain inside the shape (e.g., joints etc.). It is also possible to check that a skeleton edge is not fully inside the mesh shape and hierarchically split the bin for that region, such that more knots are added until the edges are inside the mesh shape.

Reusing the process of “Independent frame clustering and matching” as discussed above, splitting the regions into clusters may not be invariant anymore, as the relative positions of the unit normal planes may be different from frame to frame (for example, a rotation of the head or of an arm).

One approach may consist in using unit normal planes for the first frame, to cluster triangles in each region corresponding to a knot of the skeleton, and then motion compensate these clusters through frames, thanks to the tracked skeleton knot motion. Based on the motion compensated clusters' bounding volumes, such as bounding boxes for example, one can cluster the next frames corresponding regions.

Another approach may consist in using a Principal Component Analysis on each skeleton knot associated region to define principal axis and set these as normal directions for clustering. Some of the axis directions may however b unstable in case the region shape is very similar to a cylinder or a quadric in general. In that case, the corresponding UV texture map features can be used to motion compensate cluster as explained with reference to “Independent frame clustering and matching”.

Multiple Reference Frame Clustering

In another embodiment, multiple reference frames can be defined within on GoP. This can alleviate issues such as significant topology changes within on GoP, that could be present in a one-reference-frame approach described above.

In one embodiment, reference frames may be selected as follows: differences between frames are quantified using, among others, these features:
Mesh difference metrics, such as PCC-Mmetric;
Topology features, such as area, connected components (CC), and/or genus;
Change of texture (any image features such as histogram of colors can be applied to the surface);
Number of triangles (changes significantly, e.g., when arms start touching a person's body);
Size of the bounding box or bounding volume.

These features can be merged to quantize differences between mesh frames. Similar to a 2D video's adaptive GoP, reference frames can be identified by e.g. checking at which points in time, mesh frame differences exceed a predefined or adaptive threshold, and assigning reference frames accordingly.

Regarding topology features, the number of CC can be estimated as follows:
1) Set F as the set of faces in the mesh, create an empty list L of connected components;
2) Pick a random face fin the mesh, remove it from F;
3) Grow a region Rf around f by adding connected faces that are in F and remove them from F;
4) Once there are no more faces that can be added to Rf, insert Rf into the list of connected components L;
5) If F is not empty, pick a random face f and recursively grow a region as in point 3, add the region to the list of connected components L; 6) Repeat step 5 until F is empty.

The number CC may then be a number of connected components in the list L.

The genus g (number of handles) can be estimated as follows for each connected component separately, thanks to the Euler formula:

V+F−E=2−2g

where V is the number of vertices, F is the number of faces, and E is the number of edges. For special meshes that have b boundary components (such as 1 for a disk for example), the formula becomes

V+F−E=2−2g−b

Assigning dependent fames to a reference frame that shares the same CC and genus numbers is key to enable temporally stable clustering. If multiple reference frames fulfil this criterion, the reference frame with the minimum difference in terms of merged features can be choses.

Once reference frames and the assignments of each dependent frame to a reference frame are established, the clustering methods from the single reference frame approach (i.e., “Independent frame clustering and matching” and/or “Dependent frame clustering”) can be applied for each reference frame and its dependent frames.

Temporally Consistent Scaling and Rotation

Compensation of scaling and rotation of individual patches is very important for efficient coding of texture and geometry maps by using a 2D video encoder. Even small rotation or scaling of a patch will generate many high-frequency coefficients in the transform domain of the difference image, resulting in significantly increased bitrate.

During temporally consistent packing, for each individual patch, scaling and rotation parameters can be estimated and compensated.

Scaling and rotation of a patch can be estimated in a dependent frame using techniques known from computer vision, such as feature analysis, image moments, or phase correlation.

The estimated scaling factor can be directly applied to bounding volume of the patch of the dependent frame. The rotation angle should be signaled to the decoder in addition to the bounding volume. The decision on applying rotation and signalling it, should be based on Rate-Distortion analysis. For big and complex patches (in terms of texture complexity) signalling of rotation angle will provide reasonable bitrate saving and quality improvement, for small or simple patches, rotation angle can be omitted. For VVC and AV1, there is no need to compensate small rotations and scaling, since it can be handled by the video encoder.

V3C specification (ISO/IEC 23090-5) provides functionality that allows to signal up to 8 patch orientation (rotations). When asps_use_eight_orientations_flag equal to 0 then the patch orientation index for a patch with index j in a tile with tile ID equal to 1, pdu_orientation_index[i][j], is in the range of 0 to 1, inclusive When asps_use_eight_orientations_flag equal to 1 then pdu_orientation_index[i][j] is in the range of 0 to 7, inclusive. The orientation values are defined in Table 11 of ISO/IEC 23090-5.

To further extent the flexibility of the rotations of the patches and introduce patch base scaling, an extension to the V3C syntax structure can be defined as follows:

| | Descriptor |
|---|---|
| atlas_sequence_parameter_set_rbsp( ) { | |
| asps_atlas_sequence_parameter_set_id | ue(v) |
| asps_frame_width | ue(v) |
| asps_frame_height | ue(v) |
| asps_geometry_3d_bit_depth_minus1 | u(5) |
| asps_geometry_2d_bit_depth_minus1 | u(5) |
| asps_log2_max_atlas_frame_order_cnt_lsb_minus4 | ue(v) |
| asps_max_dec_atlas_frame_buffering_minus1 | ue(v) |
| asps_long_term_ref_atlas_frames_flag | u(1) |
| asps_num_ref_atlas_frame_lists_in_asps | ue(v) |
| for( i = 0; i < | |
| asps_num_ref_atlas_frame_lists_in_asps; i++ ) | |
| ref_list_struct( i ) | |
| asps_use_eight_orientations_flag | u(1) |
| ... | |
| asps_extension_present_flag | u(1) |
| if( asps_extension_present_flag ) { | |
| asps_vpcc_extension_present_flag | u(1) |
| asps_miv_extension_present_flag | u(1) |
| asps_mesh_extension_present_flag | u(1) |
| asps_extension_5bits | u(5) |
| } | |
| if( asps_vpcc_extension_present_flag ) | |
| asps_vpcc_extension( ) /* Specified in Annex H */ | |
| if( asps_miv_extension_present_flag ) | |
| asps_miv_extension( ) /* Specified in ISO/IEC | |
| 23090-12 */ | |
| if( asps_mesh_extension_present_flag ) | |
| asps_mesh_extension( ) | |
| if( asps_extension_5bits ) | |
| while( more_rbsp_data( ) ) | |
| asps_extension_data_flag | u(1) |
| rbsp_trailing_bits( ) | |
| } | |

asps_mesh_extension_present_flag equal to 1 specifies that the asps_mesh_extension( ) syntax structure is present in the atlas_sequence_parameter_set_rbsp( ) syntax structure. asps_mesh_extension_present_flag equal to 0 specifies that this syntax structure is not present. When not present, the value of asps_mesh_extension_present_flag is inferred to be equal to 0.

| | Descriptor |
|---|---|
| asps_mesh_extension( ) { | |
| asps_mesh_patch_rotation_enabled_flag | u(1) |
| asps_mesh_patch_scaling_enabled_flag | u(1) |
| } | |

asps_mesh_patch_rotation_enabled_flag equal to 1 specifies.

asps_mesh_patch_scaling_enabled_flag equal to 1 specifies.

| | Descriptor |
|---|---|
| patch_data_unit( tileID, patchIdx ) { | |
| pdu_2d_pos_x[ tileID ][ patchIdx ] | ue(v) |
| pdu_2d_pos_y[ tileID ][ patchIdx ] | ue(v) |
| pdu_2d_size_x_minus1[ tileID ][ patchIdx ] | ue(v) |
| pdu_2d_size_y_minus1[ tileID ][ patchIdx ] | ue(v) |
| pdu_3d_offset_u[ tileID ][ patchIdx ] | u(v) |
| pdu_3d_offset_v[ tileID ][ patchIdx ] | u(v) |
| pdu_3d_offset_d[ tileID ][ patchIdx ] | u(v) |
| if( asps_normal_axis_max_delta_value_enabled_flag ) | |
| pdu_3d_range_d[ tileID ][ patchIdx ] | u(v) |
| pdu_projection_id[ tileID ][ patchIdx ] | u(v) |
| pdu_orientation_index[ tileID ][ patchIdx ] | u(v) |
| if( afps_lod_mode_enabled_flag ) { | |
| pdu_lod_enabled_flag[ tileID ][ patchIdx ] | u(1) |
| if( pdu_lod_enabled_flag[ tileID ][ patchIdx ] ) { | |
| pdu_lod_scale_x_minus1[ tileID ][ patchIdx ] | ue(v) |
| pdu_lod_scale_y_idc[ tileID ][ patchIdx ] | ue(v) |
| } | |
| } | |
| if( asps_plr_enabled_flag ) | |
| plr_data( tileID, patchIdx ) | |
| if( asps_miv_extension_present_flag ) | |
| pdu_miv_extension( tileID, patchIdx ) /* Specified in | |
| ISO/IEC 23090-12 */ | |
| if( asps_mesh_extension_present_flag ) | |
| pdu_mesh_extension( tileID, patchIdx ) | |
| } | |

| | Descriptor |
|---|---|
| pdu_mesh_extension( tileID, p ) { | |
| if( asps_mesh_patch_rotation_enabled_flag ) | |
| pdu_rotation_enabled_flag[ tileID ][ p ] | u(1) |
| if( asps_mesh_patch_scaling_enabled_flag ) | |
| pdu_scaling_enabled_flag[ tileID ][ p ] | u(1) |
| if( pdu_rotation_enabled_flag[ tileID ][ p ] ) { | |
| pdu_rotation_qx[ tileID ][ p ] | i(16) |
| pdu_rotation_qy[ tileID ][ p ] | i(16) |
| pdu_rotation_qz[ tileID ][ p ] | i(16) |
| } | |
| if( pdu_scaling_enabled_flag[ tileID ][ p ] ) | |
| pdu_scale_on_x [ tileID ][ p ] | u(32) |
| pdu_scale_on_y [ tileID ][ p ] | u(32) |
| } | |

The scaling as defined by pdu_scale_on_x and pdu_scale_on_y should be applied before other transformations, since the scaling is defined in a 2D image space, whereas the rotation is defined in 3D space. The rotation is done in accordance with some predefined pivot point, e.g., top left corner of a patch.

pdu_rotation_enabled_flag[tilelD][p] equal to 1 specifies that the rotation parameters are present for the current patch p of the current atlas tile, with tile ID equal to tilelD. If pdu_rotation_enabled_flag[tilelD][p] is equal to 0, no rotation parameters are present for the current patch. If pdu_rotation_enabled_flag[tilelD][p] is not present, its value shall be inferred to be equal to 0.

pdu_scaling_enabled_flag[tilelD][p] equal to 1 specifies that the scaling parameters are present for the current patch p of the current atlas tile, with tile ID equal to tilelD. If pdu_scaling_enabled_flag[tilelD][p] is equal to 0, no scaling parameters are present for the current patch. If pdu_scaling_enabled_flag[tilelD][p] is not present, its value shall be inferred to be equal to 0.

pdu_rotation_qx[tilelD][p] specifies the x component, qX, for the rotation of the patch, for the patch with index p of the current atlas tile, with tile ID equal to tilelD, using the quaternion representation. The value of pdu_rotation_qx shall be in the range of −2¹⁴ to 2¹⁴, inclusive. When pdu_rotation_qx is not present, its value shall be inferred to be equal to 0. The value of qX is computed as follows:

qX=pdu_rotation_qx/2¹⁴

pdu_rotation_qy[tilelD][p] specifies the y component, qY, for the rotation of the patch, for the patch with index p of the current atlas tile, with tile ID equal to tilelD, using the quaternion representation. The value of pdu_rotation_qy shall be in the range of 0 to −2¹⁴ to 2¹⁴, inclusive. When pdu_rotation_qy is not present, its value shall be inferred to be equal to 0. The value of qY is computed as follows:

qY=pdu_rotation_qy/2¹⁴

pdu_rotation_qz[tilelD][p] specifies the z component, qZ, for the rotation of the patch, for the patch with index p of the current atlas tile, with tile ID equal to tilelD, using the quaternion representation. The value of pdu_rotation_qz shall be in the range of 0 to −2¹⁴ to 2¹⁴, inclusive. When pdu_rotation_qz is not present, its value shall be inferred to be equal to 0. The value of qZ is computed as follows:

qZ=pdu_rotation_qz/2¹⁴

The fourth component, qW, for the rotation of patch, for the patch with index p of the current atlas tile, with tile ID equal to tilelD, using the quaternion representation is calculated as follows:

qW=Sqrt(1−(qX²+qY²+qz²))

It should be noticed that in the context of this document qW is always positive. If a negative qW is desired, one may signal all three syntax elements, pdu_rotation_qx, pdu_rotation_qy, and pdu_rotation_qz, with an opposite sign, which is equivalent.

A unit quaternion can be represented as a rotation matrix pduRotMatrix as follows:

$$pduRotMatrix = [ \begin{matrix}1 - 2 * ( {qY}^{2} + {qZ}^{2} ) & 2 * ( qX * qY - qZ * qW ) & 2 * ( qX * qZ + qY * qW ) & 0 \\ 2 * ( qX * qY + qZ * qW ) & 1 - 2 * ( {qX}^{2} + {qZ}^{2} ) & 2 * ( qY * qZ - qX * qW ) & 0 \\ 2 * ( qX * qZ - qY * qW ) & 2 * ( qY * qZ + qX * qW ) & 1 - 2 * ( {qX}^{2} + {qY}^{2} ) & 0 \\ 0 & 0 & 0 & 1\end{matrix} ]$$

It is a requirement of bitstream conformance that qX²+qY²+qZ²<=1.

pdu_scale_on_x[tilelD][p] specifies the value of the scale, ScaleX, along the x axis for patch, for the patch with index p of the current atlas tile, with tile ID equal to tilelD, in increments of 2⁻¹⁶. The value of pdu_scale_on_x[tilelD][p], shall be in the range of 1 to 2³²−1, inclusive. When pdu_scale_on_x[tilelD][p] is not present, it shall be inferred to be equal to 2¹⁶. The value of ScaleX is computed as follows:

ScaleX=pdu_scale_on_x[tilelD][p]/2¹⁶

pdu_scale_on_y[tilelD][p] specifies the value of the scale, ScaleY, along the y axis for patch, for the patch with index p of the current atlas tile, with tile ID equal to tilelD, in increments of 2⁻¹⁶. The value of pdu_scale_on_y[tilelD][p], shall be in the range of 1 to 2³²−1, inclusive. When pdu_scale_on_y[tilelD][p] is not present, it shall be inferred to be equal to 2¹⁶. The value of ScaleY is computed as follows:

ScaleY=pdu_scale_on_y[tilelD][p]/2¹⁶

### Encoder Embodiments

The present disclosure proposes UV texture stabilization. To achieve this through projection-based techniques, (nearly) time-consistent triangle subsets (triangle clusters) of the mesh frames must be created. This can be achieved in a number of ways:

In one embodiment, the encoder creates triangle clusters independently for each frame following a consistent ruleset that yields similar clusters between frames. In a second step, the clusters between frames are matched to a reference frame using cluster features from geometry, area, and texture.

In one embodiment, a skeleton is created to track the mesh between frames. The skeleton is created using the mean geodesic distance of vertices, yielding eccentricity values. The centers of gravity of bins of eccentricity values define the skeleton's joints.

In one embodiment, multiple reference frames are defined per GoP to compensate for unpredictable changes in the mesh. To define the reference frames, frame differences are quantified using features from topology or texture. These differences are used to define groups of frames with small differences, and identifying the most suitable reference frame within each group, re-using topology and texture features.

In one embodiment, the encoder achieves temporally consistent patches by identifying scaling and rotation offsets between pairs of matching patches and compensating them. Rotation needs to be signaled in metadata and reversed in the decoder.

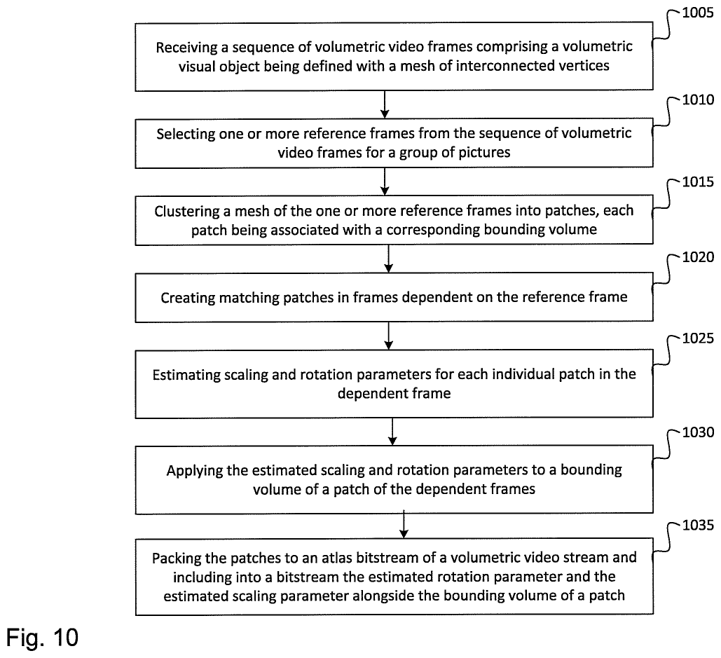

The method for encoding according to an embodiment is shown in FIG. 10. The method generally comprises receiving 1005 a sequence of volumetric video frames comprising a volumetric visual object being defined with a mesh of interconnected vertices; selecting 1010 one or more reference frames from the sequence of volumetric video frames for a group of pictures; clustering 1015 a mesh of the one or more reference frames into patches, each patch being associated with a corresponding bounding volume; creating 1120 matching patches in frames dependent on the reference frame; estimating 1025 scaling and rotation parameters for each individual patch in the dependent frame; applying 1030 the estimated scaling and rotation parameters to bounding volume of a patch of the dependent frames; and packing 1035 the patches to an atlas bitstream of a volumetric video stream and including into a bitstream the estimated rotation parameter and the estimated scaling parameter alongside the bounding volume of a patch. Each of the steps can be implemented by a respective module of a computer system.

An apparatus for encoding according to an embodiment comprises means for receiving a sequence of volumetric video frames comprising a volumetric visual object being defined with a mesh of interconnected vertices; means for selecting one or more reference frames from the sequence of volumetric video frames for a group of pictures; means for clustering a mesh of the one or more reference frames into patches, each patch being associated with a corresponding bounding volume; means for creating matching patches in frames dependent on the reference frame; means for estimating scaling and rotation parameters for each individual patch in the dependent frame; means for applying the estimated scaling and rotation parameters to bounding volume of a patch of the dependent frames; and means for packing the patches to an atlas bitstream of a volumetric video stream and including into a bitstream the estimated rotation parameter and the estimated scaling parameter alongside the bounding volume of a patch. The means comprises at least one processor, and a memory including a computer program code, wherein the processor may further comprise processor circuitry. The memory and the computer program code are configured to, with the at least one processor, cause the apparatus to perform the method of FIG. 10 according to various embodiments.

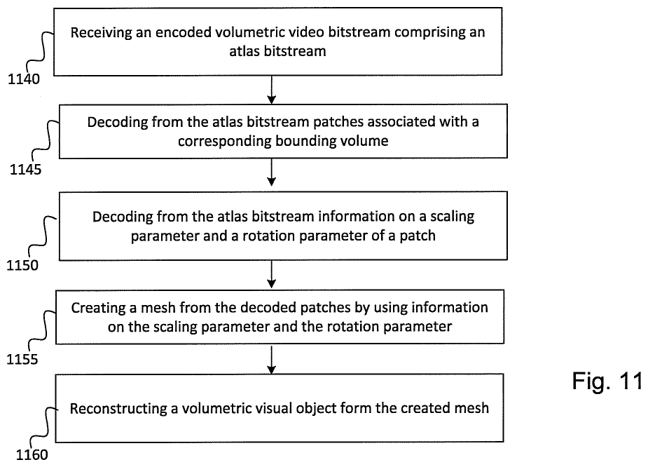

The method for decoding according to an embodiment is shown in FIG. 11. The method generally comprises receiving 1140 an encoded volumetric video bitstream comprising an atlas bitstream; decoding 1145 from the atlas bitstream patches associated with a corresponding bounding volume; decoding 1150 from the atlas bitstream information on a scaling parameter and a rotation parameter of a patch; creating 1155 a mesh from the decoded patches by using information on the scaling parameter and the rotation parameter; and reconstructing 1160 a volumetric visual object from the created mesh. Each of the steps can be implemented by a respective module of a computer system.

An apparatus for decoding according to an embodiment comprises means for receiving an encoded volumetric video bitstream comprising an atlas bitstream; means for decoding from the atlas bitstream patches associated with a corresponding bounding volume; means for decoding from the atlas bitstream information on a scaling parameter and a rotation parameter of a patch; means for creating a mesh from the decoded patches by using information on the scaling parameter and the rotation parameter; and means for reconstructing a volumetric visual object from the created mesh. The means comprises at least one processor, and a memory including a computer program code, wherein the processor may further comprise processor circuitry. The memory and the computer program code are configured to, with the at least one processor, cause the apparatus to perform the method of FIG. 11 according to various embodiments.

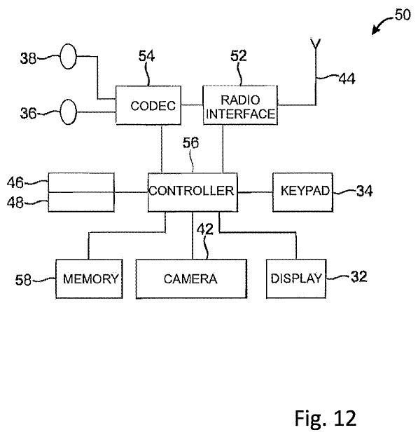

An example of an apparatus is disclosed with reference to FIG. 12. FIG. 12 shows a block diagram of a video coding system according to an example embodiment as a schematic block diagram of an electronic device 50, which may incorporate a codec. In some embodiments the electronic device may comprise an encoder or a decoder. The electronic device 50 may for example be a mobile terminal or a user equipment of a wireless communication system or a camera device. The electronic device 50 may be also comprised at a local or a remote server or a graphics processing unit of a computer. The device may be also comprised as part of a head-mounted display device. The apparatus 50 may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example, the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery (or in other embodiments of the invention the device may be powered by any suitable mobile energy device such as solar cell, fuel cell or clockwork generator). The apparatus may further comprise a camera 42 capable of recording or capturing images and/or video. The camera 42 may be a multi-lens camera system having at least two camera sensors. The camera is capable of recording or detecting individual frames which are then passed to the codec 54 or the controller for processing. The apparatus may receive the video and/or image data for processing from another device prior to transmission and/or storage.

The apparatus 50 may comprise a controller 56 or processor for controlling the apparatus 50. The apparatus or the controller 56 may comprise one or more processors or processor circuitry and be connected to memory 58 which may store data in the form of image, video and/or audio data, and/or may also store instructions for implementation on the controller 56 or to be executed by the processors or the processor circuitry. The controller 56 may further be connected to codec circuitry 54 suitable for carrying out coding and decoding of image, video and/or audio data or assisting in coding and decoding carried out by the controller.

The apparatus 50 may further comprise a card reader 48 and a smart card 46, for example a UICC (Universal Integrated Circuit Card) and UICC reader for providing user information and being suitable for providing authentication information for authentication and authorization of the user at a network. The apparatus 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es). The apparatus may comprise one or more wired interfaces configured to transmit and/or receive data over a wired connection, for example an electrical cable or an optical fiber connection.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving, and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1. An apparatus for encoding comprising:
at least one processor; and
at least one non-transitory memory storing instructions that, when executed with the at least one processor, cause the apparatus to:
receive a sequence of volumetric video frames comprising a volumetric visual object being defined with a mesh of interconnected vertices;
select one or more reference frames from the sequence of volumetric video frames for a group of pictures;
cluster a mesh of the one or more reference frames into patches, each patch being associated with a corresponding bounding volume;
create matching patches in frames dependent on the reference frame;
estimate scaling and rotation parameters for each individual patch in the dependent frame;
apply the estimated scaling and rotation parameters to bounding volume of a patch of the dependent frames; and
pack the patches to an atlas bitstream of a volumetric video stream and means for including into a bitstream the estimated rotation parameter and the estimated scaling parameter alongside the bounding volume of a patch.

2. The apparatus according to claim 1, wherein the apparatus is caused to create temporally consistent patches comprising being caused to create mesh clusters independently for each frame dependent on the reference frame, and being caused to find the most similar cluster in a reference frame for each cluster in the frame dependent on the reference frame.

3. The apparatus according to claim 1, wherein the apparatus is caused to create temporally consistent patches comprising being caused to create a skeleton of a mesh facilitating tracking of mesh changes from frame to frame.

4. The apparatus according to claim 1, wherein the apparatus is caused to create temporally consistent patches comprising being caused to create multiple reference frames for each group of frames.

5. The apparatus according to claim 1, wherein the apparatus is caused to create temporally consistent patches comprising being caused to observe whether patches have rotation and/or scaling difference between frames.

6. The apparatus according to claim 1, wherein the apparatus being caused to create matching patches from frames dependent on the reference frame comprises being caused to cluster frames dependent on the reference frame independently and to match the patches from the dependent frames to the dependent frames.

7. The apparatus according to claim 6, wherein the instructions, when executed with the at least one processor, further cause the apparatus to:
select a face from a set of unclustered faces representing the mesh as a starting point for a current cluster, and remove the selected face from the set of unclustered faces, and add the selected face to the current cluster;
determine a projection normal that has a minimum angular difference to the selected face's normal;
determine if the current face's connected face's normal is closer to the determined projection plane than to any other projection plane normal, remove the connected face from the set of unclustered faces and add the connected face to the current cluster; and continue with other connected faces that are in the set of unclustered faces until the set of unclustered faces is empty; and
match clusters within a frame to clusters from temporally neighboring frames.

8. The apparatus according to claim 1, wherein the apparatus being caused to create matching patches in frames dependent on the reference frame comprises being caused to cluster the frames dependent on the reference frame by using clustering information from the reference frame.

9. The apparatus according to claim 8, further comprising the apparatus being caused to estimate a mesh eccentricity for each frame by computing each vertex of a mesh a mean geodesic distance to all other vertices in the mesh, and to compare eccentricities between frames.

10. An apparatus for decoding comprising:
at least one processor; and
at least one non-transitory memory storing instructions that, when executed with the at least one processor, cause the apparatus to:
receive an encoded volumetric video bitstream comprising an atlas bitstream;
decode from the atlas bitstream patches associated with a corresponding bounding volume;
decode from the atlas bitstream information on a scaling parameter and a rotation parameter of a patch;
create a mesh from the decoded patches by using information on the scaling parameter and the rotation parameter; and
reconstruct a volumetric visual object from the created mesh.

11. A method for encoding, comprising:
receiving a sequence of volumetric video frames comprising a volumetric visual object being defined with a mesh of interconnected vertices;
selecting one or more reference frames from the sequence of volumetric video frames for a group of pictures;
clustering a mesh of the one or more reference frames into patches, each patch being associated with a corresponding bounding volume;
creating matching patches in frames dependent on the reference frame;
estimating scaling and rotation parameters for each individual patch in the dependent frame;
applying the estimated scaling and rotation parameters to bounding volume of a patch of the dependent frames;
packing the patches to an atlas bitstream of a volumetric video stream and including into a bitstream the estimated rotation parameter and the estimated scaling parameter alongside the bounding volume of a patch.

12. A method for decoding, comprising:
receiving an encoded volumetric video bitstream comprising an atlas bitstream;
decoding from the atlas bitstream patches associated with a corresponding bounding volume;
decoding from the atlas bitstream information on a scaling parameter and a rotation parameter of a patch;
creating a mesh from the decoded patches by using information on the scaling parameter and the rotation parameter; and
reconstructing a volumetric visual object from the created mesh.

13-14. (canceled)
